(19) United States
(12) Patent Application Publication
(10) Pub. No.: US 2014/0040385 A1
(43) Pub. Date: Feb. 6, 2014

(54) APPARATUS, SYSTEM, AND METHOD FOR EXPERT IDENTIFICATION TO ANSWER USERS QUERIES

(71) Applicants: Jake Hofman, New York, NY (US); Sharad Goel, New York, NY (US); Duncan James Watts, New York, NY (US)

(72) Inventors: Jake Hofman, New York, NY (US); Sharad Goel, New York, NY (US); Duncan James Watts, New York, NY (US)

(73) Assignee: Yahoo! Inc., Sunnyvale, CA (US)

(21) Appl. No.: 13/563,638

(22) Filed: Jul. 31, 2012

(51) Int. Cl. G06F 15/16

(52) U.S. Cl. 709/206

(57) ABSTRACT

Embodiments disclosed herein may relate to determining individual experts to answer user queries utilizing computing platform in a communication system.

### BACKGROUND

1. Field

Subject matter disclosed herein may relate to determining individual experts to answer user queries utilizing a computing platform in a communication system.

2. Information

With networks such as the Internet and local area networks gaining tremendous popularity, communications among large amounts of users are made possible. Organizations, such as businesses, for example, may employ communication networks to facilitate communications among individuals and/or groups of individuals within an organization. Organizations may further utilize messaging services, such as electronic mail (e-mail), for example, to facilitate communication among individuals and/or groups of individuals within an organization. Individuals within organizations may utilize messaging services, such as electronic mail, for example to seek answers to queries. Emails may be dispatched to other individuals that may be thought to possess an ability to answer a query. In relatively large organizations, difficulties may arise in knowing which individuals within an organization may possess expertise sufficient to answer specific queries.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic block diagram illustrating an example technique for answering a user query in accordance with an embodiment.

FIG. 2 is a schematic block diagram illustrating an example technique for answering a user query in accordance with an embodiment.

FIG. 3 is a flow diagram illustrating an example process for answering a user query in accordance with an embodiment.

FIG. 4 is an illustration depicting an example system for answering a user query in accordance with an embodiment.

FIG. 5 is a block diagram illustrating an example system comprising a plurality of computing devices coupled via a network in accordance with an embodiment.

Reference is made in the following detailed description to the accompanying drawings, which form a part hereof, wherein like numerals may designate like parts throughout to indicate corresponding and/or analogous elements. It will be appreciated that elements illustrated in the figures have not necessarily been drawn to scale, such as for simplicity and/or clarity of illustration. For example, dimensions of some elements may be exaggerated relative to other elements for clarity. Further, it is to be understood that other embodiments may be utilized. Furthermore, structural and/or logical changes may be made without departing from the scope of claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit the scope of claimed subject matter and/or equivalents.

### DETAILED DESCRIPTION

As mentioned above, organizations, such as businesses, for example, may employ communication networks to facilitate communications among individuals and/or groups of individuals within an organization. Organizations may further utilize messaging services, such as electronic mail (e-mail), for example, to facilitate communication among individuals and/or groups of individuals within an organization. Individuals within organizations may utilize messaging services, such as electronic mail, for example to seek answers to queries. Emails may be dispatched to other individuals that may be thought to possess an ability to answer a query. In relatively large organizations, difficulties may arise in knowing which individuals within an organization may possess expertise sufficient to answer specific queries.

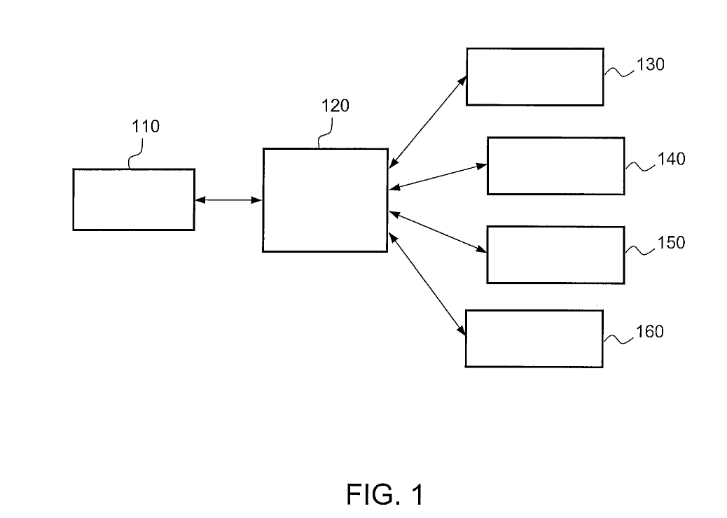

FIG. 1 is a schematic block diagram illustrating an example technique for answering a user query in accordance with an embodiment. In an organization, such as a relatively large business, for example, a user 110 may desire to have a question answered. User 110 may submit a query to a search function 120, and if search function 120 does not have an answer to the query, search function 120 may solicit answers from potential sources 130, 140, 150, and/or 160. In an example, potential sources 130-160 may comprise individuals within an organization. For the example of FIG. 1, search function 120 may individually communicate with potential sources 130-160. Emails or other types of messaging systems may be utilized to communicate with potential sources 130-160. In an example, an email containing a query may be delivered to potential sources 130-160, and if one or more of potential sources 130-160 are willing and able to answer the query, one or more potential sources 130-160 may reply to search function 120 and/or to user 110. For example, user 110 may submit a question to search function 120, and search function 120 may transmit emails to a plurality of other individuals, potential sources 130-160, in hopes that one or more of potential sources 130-160 may be able to answer the question and may also be willing to provide an answer back to search function 120 and/or to user 110.

In one example that may be typical in relatively large organizations, user 110 may have a question that user 110 desires to have answered. User 110 may perform search function 120 by searching available records and/or other sources of information readily available to user 110. For this example, in the event user 110 is unable to find a suitable answer to the question, user 110 may transmit emails to one or more other individuals within an organization to seek help in answering the question. If user 110 happens to know which other individuals within the organization have the ability to provide an answer to the question, user 110 may be successful in finding an answer to the question. However, difficulties may arise if user 110 does not know which individuals within the organization may have the ability to provide an answer. User 110 may transmit emails to various individuals, but there would be no assurance of success, and no means to progress towards finding an answer if potential sources 130-160 are unable and/or unwilling to provide an answer.

Shortcomings observed above in the typical situation of a user emailing others within an organization to seek for an answer to a question may be overcome, at least in part, by providing procedure for systematically searching for experts within an organization that are able to answer various queries. In an embodiment, a message may be delivered to a first recipient seeking an answer to a query submitted by a user. If the first recipient is able to answer the query, the first recipient may respond to the user to provide the answer. However, if the first recipient is unable to answer the question, the first recipient may forward the question to a subsequent recipient. The first recipient may select the subsequent recipient based on the first recipient's personal knowledge or opinions on who might be able to provide an answer to the query. Messages may be forwarded from one subsequent recipient to other subsequent recipients until an individual is found that is able to provide an answer to the query.

Additionally, in an embodiment, an answer to the query may be provided to the user who submitted the query, and the answer may also be stored in a record so that future searches for answers to similar queries may be readily provided. In an embodiment, one or more tags related to the query and/or query answer may be stored in one or more records of a memory. The one or more tags may comprise, for example, text elements that may aid in future searches. A tag may describe elements related to a query's subject matter, for example. Also, in an embodiment, an individual that provides an answer to a query may be tagged as an “expert” as it relates to the subject matter of the query. A label may be stored in the one or more records of the memory to identify one or more experts with respect to the query and/or query answer, for example. As used herein, the term “expert” as it relates to a particular query and/or query answer is meant to identify an individual having a capability to provide a suitable answer to the particular query. Suitability of an answer may be determined, in an embodiment, by the user who submitted the query, although claimed subject matter is not limited in scope in this respect.

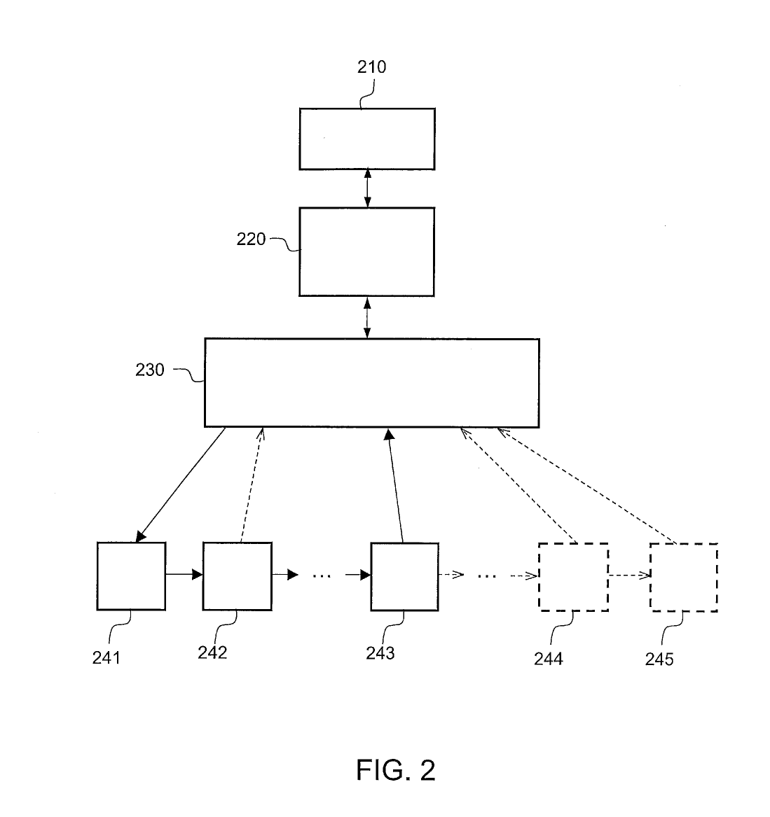

FIG. 2 is a schematic block diagram illustrating an example technique for answering a user query in accordance with an embodiment. A user 210 may submit a query to a search function 220, for example. Search function 220 may comprise one or more records of a memory containing answers responsive to previous queries, and/or may store information that may be searched in an effort to find a suitable answer to the submitted query. If a suitable answer to the submitted query is found in the one or more records, search function 220 may provide the answer to user 210. However, if the one or more records does not have stored therein a suitable answer to the query, a messaging function 230 may transmit a message comprising the query to a first recipient 241. First recipient 241 may be designated by user 210 in an embodiment, although claimed subject matter is not limited in this respect. In another embodiment, first recipient 241 may be selected by search function 220 and/or by messaging function 230.

First recipient 241 may review the submitted query, and may determine whether first recipient 241 is able to provide an answer to the query. If first recipient 241 is able to provide an answer, the answer may be delivered to search function 220 and/or user 210 via messaging function 230, in an embodiment. Search function 220 may store the answer in a record of a memory for future searches on similar queries, and first recipient 241 may be labeled within the record as an expert as it relates to the query and/or query answer. If, however, first recipient 241 is not able to provide a suitable answer to the submitted query, first recipient may forward the query to a subsequent recipient 242. In an embodiment, messaging function 230 may track messages related to the query, including storing information indicating that the query has been forwarded from first recipient 241 to a subsequent recipient 242.

As depicted in FIG. 2, if recipient 242 is unable to answer the query, the query may be forwarded to another subsequent recipient, such as subsequent recipient 243. Any number of subsequent recipients, including example potential recipients 244 and 245, may receive and inspect the query to determine whether they have the expertise that would enable them to answer the query. For the example of FIG. 2, recipient 243 may have the expertise to answer the query, and may provide an answer to the query to searching function 220 by way of messaging function 230. Recipient 243 may be labeled as an expert as it relates to the present query, and search function 220 may store a label identifying recipient 243 as an expert in a record of a memory. In an embodiment, search function 220 may also store one or more tags describing one or more aspects of the subject matter of the present query.

Further, in an embodiment, messaging function 230 may track the progress of a query as it is forwarded from recipient to recipient, and may take steps to ensure progress towards a resolution of the query is maintained until an answer is obtained, or until possibilities of where to look for an answer to a query are exhausted. For example, messaging function 230 may track how long a query message has resided at a recipient's computing platform. If a configurable amount of time has elapsed without either receiving an answer or the query being forwarded to a subsequent recipient, messaging function 230 may remind the current recipient and/or may alert user 210, in an embodiment. Also, in an embodiment, if a configurable amount of time has elapsed without either receiving an answer or the query being forwarded to a subsequent recipient, messaging function 230 may restart the process by transmitting the query to a new recipient with an objective to restart the search for a recipient with the expertise to answer the query.

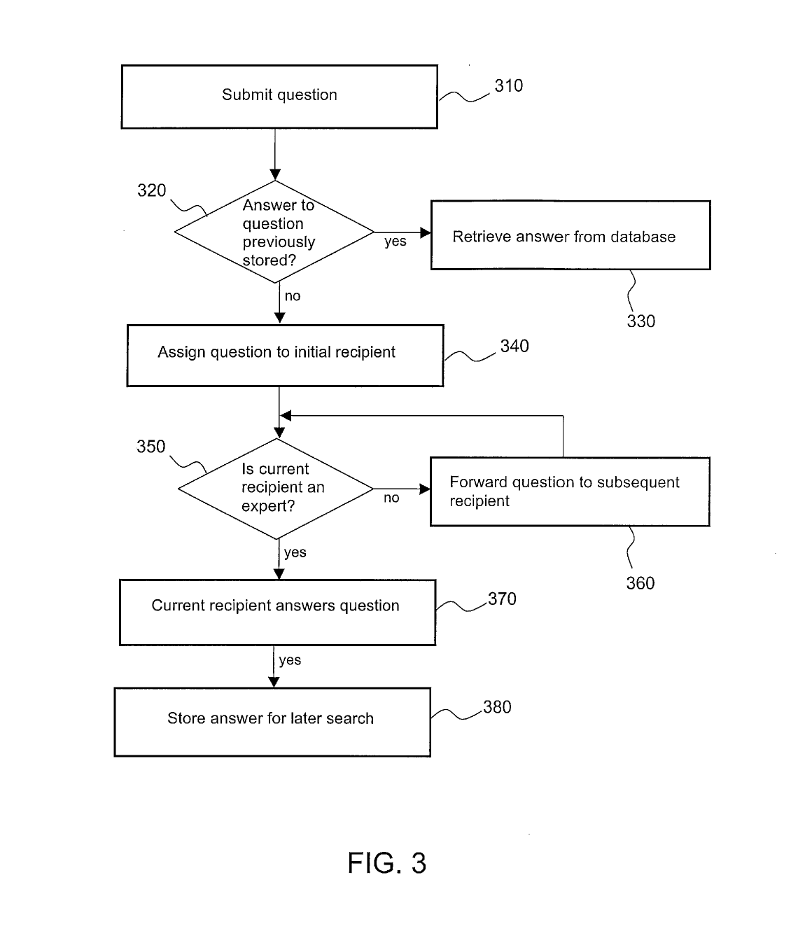

FIG. 3 is a flow diagram illustrating an example process for answering a user query in accordance with an embodiment. At block 310, a question may be submitted by a user. As used herein, the terms “query” and “question” may be used interchangeably. The question may comprise a question for which the user does not have the expertise to answer, and for which the user believes others within an organization do have the requisite expertise. At block 320, a determination may be made as to whether the submitted question has an answer previously stored in a record of a memory. As indicated at block 330, an answer may be retrieved from the record if the answer is determined to have been previously stored in the record. However, if an answer to the question is determined to not have been previously stored in the record, the question may be assigned to an initial recipient at block 340.

Continuing with the example embodiment depicted in FIG. 3, a determination may be made as to whether a current recipient is an expert, as it relates to the question presented by the user at block 350. In an embodiment, the determination may be made by the current recipient. If the current recipient determines that the expertise needed to answer the question in an appropriate manner is not held by the current recipient, the question may be forwarded to a subsequent recipient. In an embodiment, the next recipient may be identified by the current recipient, wherein the current recipient relies on his/her own knowledge of individuals within the organization to determine an appropriate subsequent recipient. In another embodiment, messaging function 230 and/or searching function 220 may determine a subsequent recipient, although claimed subject matter is not limited in this respect.

A subsequent recipient, now referred to as the current recipient, may determine at block 350 whether the current recipient has expertise sufficient to answer the question provided by the user. Again, if the current recipient is unable to answer the question, a subsequent recipient is identified and the question is forwarded at block 360. This process may continue until an individual with sufficient expertise to be able to answer the question is identified. If a determination is made at block 350 that a current recipient is an expert as it relates to the submitted question, the current recipient may answer the question at block 370. At block 380, the answer may be stored in a record of a memory for later search. In an embodiment, information related to the submitted question and the answer to the question supplied by the answering recipient may also be stored in a record of a memory to aid future searches for answers to similar questions.

In an embodiment, queries may be tagged by the initiator of the query. Such tags may describe, at least in part, one or more aspects of a submitted query. As mentioned above, a tag may comprise one or more text elements that are associated with a submitted query. In an embodiment, a query may be tagged by the initiator, and an answer to the query may be submitted by a particular recipient. One, or more records of a memory may store the tags associated with the query and may also store a label identifying the answering recipient. In this manner, recipients may be associated with various tags, and future searches may be enhanced by using such information. For example, if a question is submitted with subject matter that is related to a previous question, an initial recipient of the question may be selected based, at least in part, on the identity of an individual that provided an answer to the previous question. In this manner, a system may be provided for automatically labeling experts, thereby improving future searches.

Embodiments described herein may utilize electronic mail systems to transmit query messages from recipient to recipient. However, claimed subject matter is not limited in scope in this respect. For example, other embodiments are possible that may make use of other types of messaging services, including short message services, or message services associated with social media applications, for example.

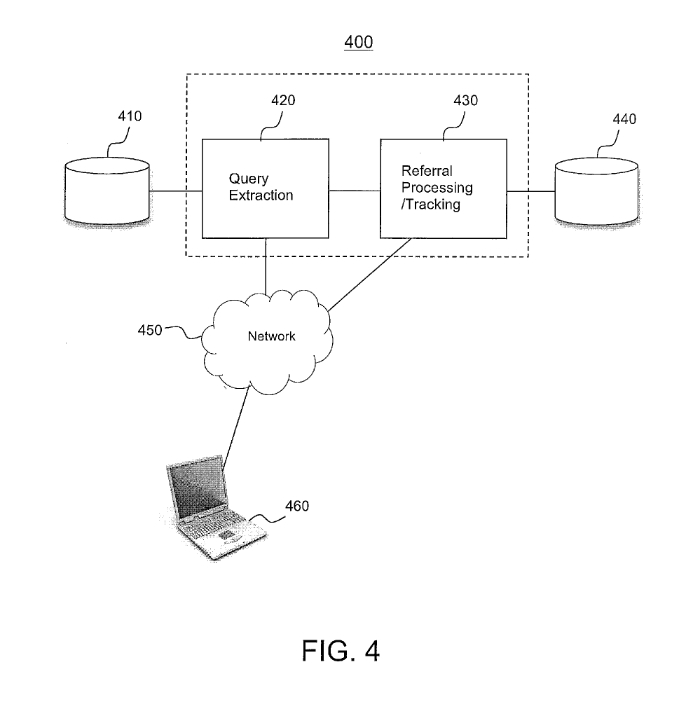

FIG. 4 is an illustration depicting an example system for answering a user query in accordance with an embodiment. A user may interact with a computing platform 460 to submit queries to query answering system 400 via a network 450. In an embodiment, network 450 and system 400 may be part of a local area network associated with an organization, although claimed subject matter is not limited in these respects. In another embodiment, network 450 and system 400 may communicate via the Internet and may form part of the World Wide Web, for example.

Query answering system 400 may comprise a query extraction unit 420 and a referral processing and tracking unit 430. In an embodiment, query answering system 400 may search one or more records of a memory 410 for an answer to the query provided by user computing platform 460 from among previously stored answers in one or more records of memory 410. System 400 may utilize tags provided by a user to aid in a search for a previous answer in the records of memory 410. If an answer to the submitted query is not located in the records of memory 410, referral processing and tracking unit 430 may select an initial recipient from among a plurality of potential recipients of messaging system 440 and may transmit a message comprising the submitted query to the initial recipient. In an embodiment, referral processing and tracking unit 430 may use information provided by the user to determine an initial recipient.

In an embodiment, messaging system 440 may comprise an email system utilized within an organization. The initial recipient may determine whether to answer the query or to forward the query to a subsequent recipient. In an embodiment, the initial recipient may determine to which other recipient to forward the query. Such a determination may be made, at least in part, based on the initial recipient's knowledge of the organization and the people within the organization with which the initial recipient may be familiar. Alternatively, in another embodiment, the initial recipient may indicate an inability to answer the question to the referral processing and tracking system 430, and referral processing and tracking system 430 may determine a subsequent recipient.

In embodiments described herein, various recipients may receive messages. Messages, such as electronic mail, may be received by the recipients at client computing platforms. As discussed more fully below, the term “computing platform” may comprise any of a wide range of electronic devices that include the ability to process and/or store data in the form of signals or states. Example types of computing platforms may include personal computers, cellular telephones, tablet devices, and personal digital assistants, although claimed subject matter is not limited in scope in this respect. Thus, embodiments described herein may utilize any type of computing platform to submit queries, to perform searches, to transmit and/or receive messages, and so forth.

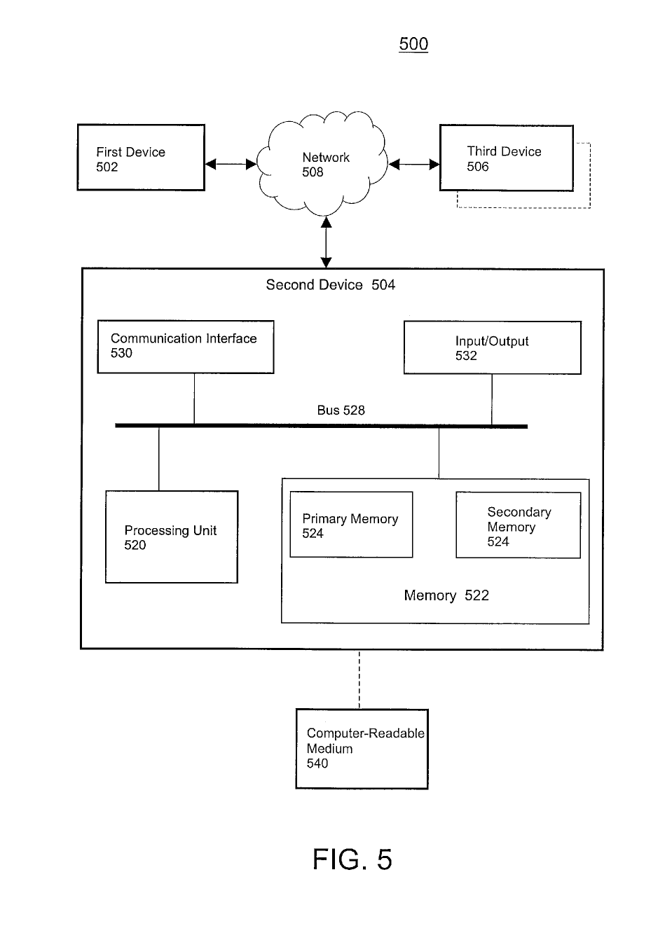

FIG. 5 is a schematic diagram illustrating an exemplary embodiment 500 of a computing environment system that may include one or more devices configurable to implement techniques and/or processes described above related to finding experts to answer queries discussed above in connection with FIGS. 1-4, for example. System 500 may include, for example, a first device 502, a second device 504, and a third device 506, which may be operatively coupled together through a network 508.

First device 502, second device 504 and third device 506, as shown in FIG. 5, may be representative of any device, appliance or machine that may be configurable to exchange data over network 508. By way of example but not limitation, any of first device 502, second device 504, or third device 506 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 508, as shown in FIG. 5, is representative of one or more communication links, processes, and/or resources configurable to support the exchange of data between at least two of first device 502, second device 504, and third device 506. By way of example but not limitation, network 508 may include wireless and/or wired communication links, telephone or telecommunications systems, data buses or channels, optical fibers, terrestrial or satellite resources, local area networks, wide area networks, intranets, the Internet, routers or switches, and the like, or any combination thereof. As illustrated, for example, by the dashed lined box illustrated as being partially obscured of third device 506, there may be additional like devices operatively coupled to network 508.

It is recognized that all or part of the various devices and networks shown in system 500, and the processes and methods as further described herein, may be implemented using or otherwise include hardware, firmware, software, or any combination thereof (other than software per se).

Thus, by way of example but not limitation, second device 504 may include at least one processing unit 520 that is operatively coupled to a memory 522 through a bus 528.

Processing unit 520 may be representative of one or more circuits configurable to perform at least a portion of a data computing procedure or process. By way of example but not limitation, processing unit 520 may include one or more processors, controllers, microprocessors, microcontrollers, application specific integrated circuits, digital signal processors, programmable logic devices, field programmable gate arrays, and the like, or any combination thereof.

Memory 522 may be representative of any data storage mechanism. Memory 522 may include, for example, a primary memory 524 and/or a secondary memory 526. Primary memory 524 may include, for example, a random access memory, read only memory, etc. While illustrated in this example as being separate from processing unit 520, it should be understood that all or part of primary memory 524 may be provided within or otherwise co-located/coupled with processing unit 520.

Secondary memory 526 may include, for example, the same or similar type of memory as primary memory and/or one or more data storage devices or systems, such as, for example, a disk drive, an optical disc drive, a tape drive, a solid state memory drive, etc. In certain implementations, secondary memory 526 may be operatively receptive of, or otherwise configurable to couple to, a computer-readable medium 540. Computer-readable medium 540 may include, for example, any medium that can carry and/or make accessible data, code and/or instructions for one or more of the devices in system 500.

Second device 504 may include, for example, a communication interface 530 that provides for or otherwise supports the operative coupling of second device 504 to at least network 508. By way of example but not limitation, communication interface 530 may include a network interface device or card, a modem, a router, a switch, a transceiver, and the like.

Second device 504 may include, for example, an input/output 532. Input/output 532 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 532 may include an operatively configured display, speaker, keyboard, mouse, trackball, touch screen, data port, etc.

The term “computing platform” as used herein refers to a system and/or a device that includes the ability to process and/or store data in the form of signals or states. Thus, a computing platform, in this context, may comprise hardware, software, firmware or any combination thereof (other than software per se). Computing platform 500, as depicted in FIG. 5, is merely one such example, and the scope of claimed subject matter is not limited in these respects. For one or more embodiments, a computing platform may comprise any of a wide range of digital electronic devices, including, but not limited to, personal desktop or notebook computers, high-definition televisions, digital versatile disc (DVD) players or recorders, game consoles, satellite television receivers, cellular telephones, personal digital assistants, mobile audio or video playback or recording devices, or any combination of the above. Further, unless specifically stated otherwise, a process as described herein, with reference to flow diagrams or otherwise, may also be executed and/or controlled, in whole or in part, by a computing platform.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

Methodologies described herein may be implemented by various techniques depending, at least in part, on applications according to particular features or examples. For example, methodologies may be implemented in hardware, firmware, or combinations thereof, along with software (other than software per se). In a hardware embodiment, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter.

Some portions of the preceding detailed description have been presented in terms of logic, algorithms and/or symbolic representations of operations on binary states stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “selecting”, “generating”, or the like may refer to actions and/or processes of a specific apparatus, such as a special purpose computer or a similar special purpose electronic computing device. In the context of this specification, therefore, a special purpose computer and/or a similar special purpose electronic computing device is capable of manipulating and/or transforming signals, typically represented as physical electronic and/or magnetic quantities within memories, registers, and/or other information storage devices, transmission devices, or display devices of the special purpose computer and/or similar special purpose electronic computing device. In the context of this particular patent application, the term “specific apparatus” may include a general purpose computer once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change and/or transformation in magnetic orientation or a physical change and/or transformation in molecular structure, such as from crystalline to amorphous or vice-versa. In still other memory devices, a change in physical state may involve quantum mechanical phenomena, such as, superposition, entanglement, or the like, which may involve quantum bits (qubits), for example. The foregoing is not intended to be an exhaustive list of all examples in which a change in state for a binary one to a binary zero or vice-versa in a memory device may comprise a transformation, such as a physical transformation. Rather, the foregoing are intended as illustrative examples.

A computer-readable (storage) medium typically may be non-transitory and/or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

While there has been illustrated and/or described what are presently considered to be example features, it will be understood by those skilled in the art that various other modifications may be made, and/or equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and/or equivalents thereof.

1. A method, comprising:
receiving one or more signals indicative of a query from a user computing platform at a server computing platform;
determining whether an answer to the query is stored in a record in a non-transitory memory;
transmitting one or more signals indicative of a message to a first client computing platform associated with a first recipient at least in part in response to a determination that the answer to the query is not stored in the record, the message comprising the query; and
transmitting one or more signals indicative of one or more subsequent messages to one or more subsequent client computing platforms associated with one or more subsequent recipients at least in part in response to receiving an indication from the first recipient to forward the query to an additional recipient.

2. The method of claim 1, further comprising selecting the first recipient based at least in part on one or more labels stored in the record identifying the first recipient as an expert with respect to one or more previous queries.

3. The method of claim 2, wherein the one or previous queries comprise one or more previous queries having subject matter related at least in part to a subject matter of the query received from the user.

4. The method of claim 1, wherein said transmitting the one or more signals indicative of the one or more subsequent messages comprises transmitting a first subsequent message from the first recipient to a first subsequent recipient at least in part in response to said receiving the indication from the first recipient to forward the query to the additional recipient.

5. The method of claim 1, wherein said transmitting the one or more signals indicative of the one or more subsequent messages comprises repeatedly transmitting messages from one of the one or more subsequent recipients to another of the one or more subsequent recipients until an answer to the query is received from any of the one or more subsequent recipients.

6. The method of claim 5, further comprising storing a label associated with the subsequent recipient from which the answer is received, the label to identify the subsequent recipient from which the answer is received as an expert with respect to the query.

7. A method, comprising:
receiving one or more signals indicative of a query from a user computing platform at a server computing platform;
determining whether an answer to the query is stored in a record of a non-transitory memory; and
transmitting one or more signals indicative of a message to a first client computing platform associated with a first recipient at least in part in response to a determination that the answer to the query is not stored in the record, the message comprising the query and further comprising instructions to be followed by the first recipient, the instructions indicating to the first recipient to provide the answer to the query and to forward the message to an additional recipient if the first recipient does not provide the answer to the query.

8. The method of claim 7, further comprising receiving one or more signals indicative of the answer to the query from the first client computing platform at least in part in response to the first recipient providing the answer to the query.

9. The method of claim 7, further comprising receiving one or more signals indicative of the answer to the query from an additional client computing platform associated with the additional recipient at least in part in response to the additional recipient providing the answer to the query.

10. The method of claim 7, further comprising tagging the query provided by the user at least in part in accordance with one or more tags provided by the user.

11. The method of claim 10, wherein said tagging the query comprises storing the one or more tags and the query in the record and associating the tags with the query.

12. The method of claim 11, further comprising:
receiving one or more signals indicative of the answer to the query from the first client computing platform or from an additional client computing platform associated with the additional recipient; and
storing a label associated with the first recipient or the additional recipient in the record and associating the label with the first recipient or the additional recipient at least in part in response to said receiving the answer from the first client computing platform or from the additional client computing platform, the label to identify the first recipient or the additional recipient as an expert with respect to the query.

13. An article, comprising: a computer-readable medium having stored thereon instructions executable by a processor of a computing platform to:
receive a query from a user;
determine whether an answer to the query is stored in a memory of the computing platform;
initiate transmission of a message to a first client computing platform associated with a first recipient at least in part in response to a determination that the answer to the query is not stored in the memory, the message comprising the query; and
initiate transmission of one or more subsequent messages to one or more subsequent client computing platforms associated with one or more subsequent recipients at least in part in response to receiving an indication from the first recipient to forward the query to an additional recipient.

14. The article of claim 13, wherein the computer-readable medium has stored thereon further instructions executable by the processor of the computing platform to select the first recipient based at least in part on one or more labels stored in the memory identifying the first recipient as an expert with respect to one or more previous queries.

15. The article of claim 14, wherein the one or previous queries comprise one or more previous queries having subject matter related at least in part to a subject matter of the query received from the user.

16. The article of claim 13, wherein the computer-readable medium has stored thereon further instructions executable by the processor of the computing platform to initiate transmission of the one or more signals indicative of the one or more subsequent messages at least in part by initiating transmission of a first subsequent message from the first recipient to a first subsequent recipient at least in part in response to said receiving the indication from the first recipient to forward the query to the additional recipient.

17. The article of claim 13, wherein the computer-readable medium has stored thereon further instructions executable by the processor of the computing platform to initiate transmission of the one or more signals indicative of the one or more subsequent messages at least in pad by repeatedly initiating transmission of messages from one of the one or more subsequent recipients to another of the one or more subsequent recipients until an answer to the query is received from any of the one or more subsequent recipients.

18. The article of claim 17, wherein the computer-readable medium has stored thereon further instructions executable by the processor of the computing platform to store a label associated with the subsequent recipient from which the answer is received, the label to identify the subsequent recipient from which the answer is received as an expert with respect to the query.

19. An apparatus, comprising:
a communication interface to receive one or more signals indicative of a query from a user computing platform at a server computing platform;
a memory to store a record; and
a processing unit to determine whether an answer to the query is stored in the record, the communication interface to transmit one or more signals indicative of a message to a first client computing platform associated with a first recipient at least in part in response to a determination that the answer to the query is not stored in the record, the message comprising the query, the communication interface further to transmit one or more signals indicative of one or more subsequent messages to one or more subsequent client computing platforms associated with one or more subsequent recipients at least in part in response to receiving an indication from the first recipient to forward the query to an additional recipient.

20. The apparatus of claim 19, the processor to select the first recipient based at least in part on one or more labels stored in the record identifying the first recipient as an expert with respect to one or more previous queries.

21. The apparatus of claim 20, wherein the one or previous queries comprise one or more previous queries having subject matter related at least in part to a subject matter of the query received from the user.

22. The apparatus of claim 19, the communication interface to transmit the one or more signals indicative of the one or more subsequent messages at least in part by transmitting a first subsequent message from the first recipient to a first subsequent recipient at least in part in response to said receiving the indication from the first recipient to forward the query to the additional recipient.

23. The apparatus of claim 19, the communication interface to transmitting the one or more signals indicative of the one or more subsequent messages at least in part by repeatedly transmitting messages from one of the one or more subsequent recipients to another of the one or more subsequent recipients until an answer to the query is received from any of the one or more subsequent recipients.

24. The apparatus of claim 23, the processor to store a label associated with the subsequent recipient from which the answer is received, the label to identify the subsequent recipient from which the answer is received as an expert with respect to the query.
